(19) United States
(12) Patent Application Publication
(10) Pub. No.: US 2008/0012935 A1
(43) Pub. Date: Jan. 17, 2008

(54) Inappropriate content detection and distribution prevention for wireless cameras/camcorders with e-mail capabilities and camera phones

(75) Inventor: Patti Echtenkamp, Jackson, NE (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/284,717

(22) Filed: Nov. 22, 2005

(51) Int. Cl. H04N 7/14

(52) U.S. Cl. 348/14.02; 348/14.01

(57) ABSTRACT

Systems and methods are provided for preventing the transmission of pornographic or otherwise undesirable material from a wireless device. The wireless device 100 can be a device capable of capturing and storing video or photographic data. Prior to transmitting the video or photographic data, filter 110 can detect whether the content of the video or photographic data is pornographic or otherwise undesirable and thereby prevent the transmission of that data.

### FIELD OF THE INVENTION

The present invention relates generally to the recording and transmitting of images and videos. More specifically the present invention relates to apparatus and methods for filtering certain content from devices that record and transmit images and videos.

### BACKGROUND OF THE INVENTION

Recently there have been many discussions amongst various law making entities and the news media regarding a growing problem with the distribution of various types of media content to minors and those not interested or opposed to the material. This objectionable, sometimes pornographic media is now capable of being transmitted through a variety of common devices that now have the capabilities to both capture and wirelessly transmit various types of media. Items, such as mobile phones that now include cameras for recording both images and video, have become commonplace in the market. Additionally, many digital cameras and video recorders (camcorders) now include wireless transmission capabilities that aid the user in putting the media onto, for example, a home computer or the Internet. Instances of pornographic images being captured by these devices and transmitted or disseminated to undesiring or unknowing third parties are occurring with more frequency.

With traditional cameras and video recorders, a person typically was able to know that they were being photographed or filmed. Additionally, due to the nature of film and videotape, the contents of the film or tape could not be easily widely disseminated. The recent transition from film to digital storage devices has made it easier to capture an image or video and upload it to the Internet, allowing a potentially unlimited number of viewers to see the subject of the photograph or video.

The modern trend of using portable phones equipped with still image cameras and video cameras increases the risk that a person may be subject to being filmed without their knowledge. Since portable phones have the ability of a to immediately transfer data after it has been captured on the device, an image or video of that subject could be transmitted to another person for viewing immediately after they are photographed or filmed. Further, with many modern phones having Internet capabilities, photos or video of a person could be uploaded to the Internet, making the data available for any number of viewers.

In addition to the above problem, people having camera phones and other portable electronic devices capable of receiving images and videos may be unknowingly sent images or videos, such as obscene or pornographic images, that they do not desire to view. Whether the image or video is sent as spam, by accident or through some other manner, people using camera phones may be unwittingly subjected to material that they deem offensive or undesirable.

Several countries, including the United States, are presently considering or enacting laws making it illegal to photograph a person without their permission or in certain compromising situations. Other countries, such as South Korea, require that all camera phones make a clearly audible noise when a photograph is taken. Other private locations where privacy or secrecy is desired have banned the use and even presence of camera phones inside of their facilities. Such laws and restrictions, however, typically only act to forbid the act of covertly taking pictures or video of unknowing people without addressing the transmission of the media.

What is therefore needed is a way of detecting and limiting the distribution of inappropriate content being sent to and from camera phones and other portable electronic devices with electronic transmission capabilities. This technology should protect not only those who knowingly pose and send these images to their friends, but also those who have had unauthorized pictures or video taken of them.

### SUMMARY OF THE INVENTION

Various exemplary embodiments provide methods and apparatus for filtering and/or preventing the transmission of certain data from wireless transmission devices. At least one embodiment of the invention includes detecting the presence of unwanted or pornographic visual data on a wireless transmission device and prevents the transmission of this media. The data may be filtered through software utilizing recognition technology that allows the device to determine the contents of the media. In one exemplary embodiment, the wireless device may then prevent the device from transmitting the media. In another exemplary embodiment, the wireless device may delete the media from the device. In yet another exemplary embodiment, the wireless device may temporarily or permanently disable the capability of the wireless device to wirelessly transmit media of any type. In another exemplary embodiment, the wireless device may report the user of the device to an appropriate entity.

### BRIEF DESCRIPTION OF THE DRAWINGS

Embodiments of the present invention will become more fully understood from the detailed description and the accompanying drawings, wherein:

FIG. 1 depicts aspects of wireless devices used to capture and transmit electronic data.

FIGS. 2A and 2B are flowcharts depicting two exemplary embodiments of a data filtering system for wireless transmission devices.

### DETAILED DESCRIPTION

The following description of the various exemplary embodiments is illustrative in nature and is not intended to limit the invention, its application, or uses.

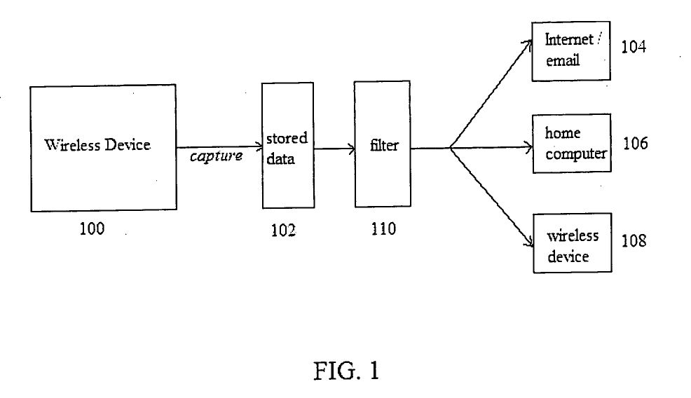

FIG. 1 illustrates an exemplary diagram of modern wireless transmission devices and their capabilities. These wireless devices 100 may include any devices with the capability of capturing and sending data wirelessly, including, for example, cellular telephones or other wireless radio communication devices (“camera phones”), digital cameras, digital video recorders (camcorders), personal digital assistants (PDAs), or other like consumer electronic devices with wireless capabilities to capture and send visual data. Due to the concealment of cameras in small wireless phones and the decreasing size of digital cameras and digital video recorders, these devices may be used to covertly capture images or video of people without their knowledge. After this visual data is captured, it becomes stored data 102, which may be housed on wireless device 100. Stored data 102 may be transmitted by any of a variety of means, depending on the device, such as frequency, time and code division multiple access, 802.11b/g wireless transmission or Bluetooth. The transmitted data may be sent to any of a variety of devices capable of receiving the transmitted data format. These devices include other wireless devices 104, such as phone-to-phone transmissions. Additionally, the wireless device 100 may transmit directly to a home computer 106 that is associated with a network. Further, wireless device 100 could transmit the data directly to the Internet or to a person's email account 108. These transmissions can take place at a variety of speeds and can occur almost instantaneously after the data is captured on the wireless device. Thus, it would be desirable to have a filter through which transmission could be sent.

To remedy the above problem, a software filter 110 may be used to detect inappropriate content, for example a certain percentage of flesh-tone color in the picture, nudity or skin, genitalia or breasts. In one embodiment of the invention, the software filter 110 may be incorporated into wireless cameras and video cameras with wireless transmission capabilities as well as camera phones having camera and video capabilities.

Software algorithms for the detection and recognition of human faces in a digital image currently exist. In one such use, an algorithm may take an image of, for example, a person's face, as captured by a digital camera. The algorithm then divides the image data into sections, each section depicting a unique characteristic, such as distance between the person's eyes or the relative height of their cheekbones. These sections are then individually compared to different templates for each section. Through the comparison of several unique characteristics and data points, the algorithms can determine if the image of a person in a digital photograph matches that of a person in a database. Further, the use of certain data points on a human face allow for the technology to correctly identify a person despite that person's use of some disguises, such as facial hair, concealing makeup or facial putty.

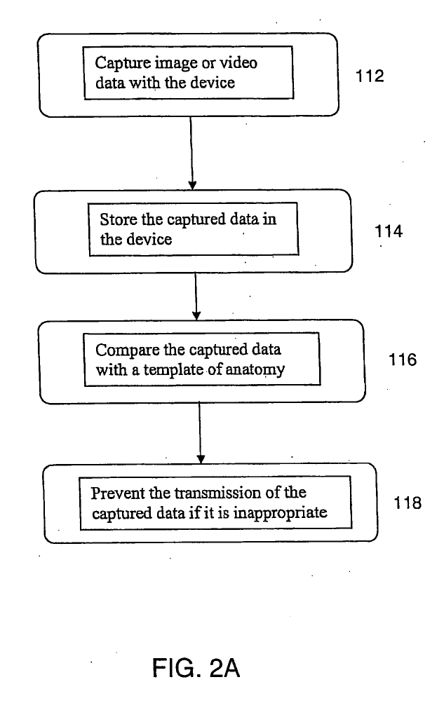

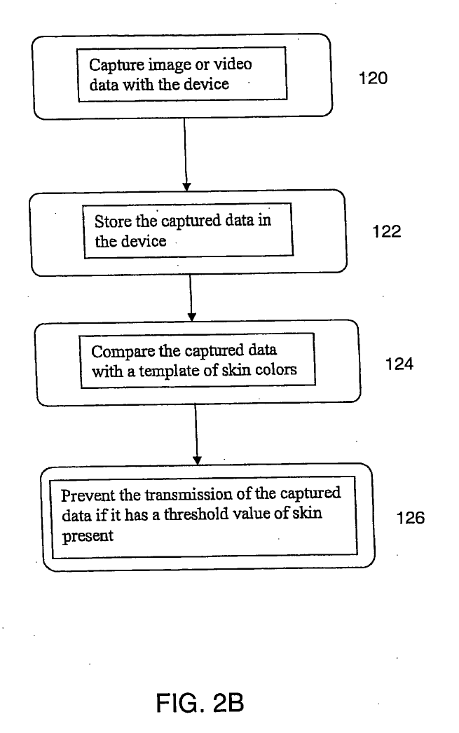

In one embodiment of the invention, such an algorithm may be adapted to detect the presence of certain human characteristics, portions of the anatomy, or a large percentage of skin or flesh-tone color which may be considered inappropriate, offensive or pornographic. For the purposes of this application, “pornographic materials” shall include any materials deemed pornographic under the application standard of law in the jurisdiction where the transmission is to be sent or received. FIG. 2A is an exemplary flowchart showing how currently available software can be implemented to check for inappropriate content. Image or video data may first be captured in step 112 by a wireless device capable of capturing and transmitting either an image or video. This data is then stored 114 in the device's memory. After the data is stored, it is quickly dissected using appropriate software and several aspects of the data may be analyzed and compared to a template 116. For example, certain characteristics of male or female genitalia or other portions of the anatomy could be compared against known templates. The known templates may be groups of known pornographic images and content. If inappropriate content is deemed to be housed within the data of the photograph or video, the algorithm could take a further step to prevent transmission 118 of the inappropriate content.

FIG. 2B shows another exemplary embodiment of the invention. Similar to the steps shown in FIG. 2A, image or video data is first captured 120 and then stored 122 by a wireless transmission device capable of performing these functions. The data is then analyzed and compared 124 by the appropriate software to determine if a predetermined amount of human skin is shown in the data. If the amount of skin present in the data exceeds a threshold, the software will then take one of a variety of steps to prevent the transmission 126 of the data.

In a further embodiment of the present invention, the data comparisons depicted in FIGS. 2A and 2B may be used together. In this embodiment, the scanning of the data for characteristics of male or female genitalia or other parts of human anatomy could be combined with the determination of the amount of skin present in the data. The software may perform one scan immediately prior to performing the second scan. Then, if either one of the scans reveals the presence of inappropriate content, transmission of that data may be prevented. Additionally, if a combination of the two scans reveals data that may be inappropriate, the transmission of this data may be blocked.

Upon the detection of the inappropriate content in either step 116 in FIG. 2A or step 124 in FIG. 2B, the software could perform one of several different actions for step 118 in FIG. 2A or step 126 in FIG. 2B in order to prevent the transmission of the inappropriate content in either step. These actions are discussed in one exemplary pattern and each individual action could be performed in any of a variety of different patterns or manners. For example, each of these actions may be enacted by the software individually, concurrent with another action or following another action that is taken by the software.

In one exemplary embodiment of the invention, the software could disable the send button or wireless capability of the device to send the image or video upon the detection of inappropriate content. Alternatively, the software could “scramble” or digitally mask the content. The “scrambling” or digital masking could affect the entire contents, for example by blurring an entire image, or merely affect the offending portions of the contents, such as blurring a portion of the human anatomy through the use of strategic mosaic blurring. Mosaic blurring is a data filtering technique wherein the pixels representing portions of an image or video that need to be concealed are rearranged and expanded to cover a certain area, thus rendering that area covered by mosaic blocks and therefore unviewable. Digital masking can occur when a non-offensive image or object is placed over the offending portion or portions of an image or video.

In a further embodiment of the invention, the software could automatically delete the inappropriate image or video upon detection. This feature would have the effects of preventing an image or video from being transmitted as well as preventing the person who captured the image or video from showing displaying or broadcasting it to other parties. This feature could be especially useful to prevent a user from taking photographs or video of subjects without their knowledge or while they are in a compromising or embarrassing situation.

In another embodiment of the invention, a notification could be sent to the telephone, address or email address of the person to whom the device is registered. Such a notification could be particularly useful, for example, if the device is registered to an adult who is providing the phone for their child or a minor. A message could also be sent to local authorities, depending on the nature of the contents.

In a further embodiment of the invention, the software could also take the step of disabling the transmission capabilities of the wireless device in steps 118 and 126 of FIGS. 2A and 2B, respectively. This action would have immediate effect of preventing a user from sending the image or video to another party. Additionally, this could act as a warning to the user if coupled with a message indicating why the device's transmission capabilities had been disabled. In this embodiment, the transmission capabilities of the phone could be suspended for a temporary basis if the attempted inappropriate or pornographic transmission was a first time offense or an accidental transmission. However, in the event of a repeat offender, the transmission capabilities of the wireless device could be permanently disabled. In this embodiment, the software associated with the filter would have memory in which the number of attempts to transmit inappropriate or pornographic data could be tracked. Thus, the wireless camera/camcorder or camera phone having wireless transmission capabilities would no longer be able to transmit images or video upon notification of a predetermined number of blocked transmissions. The transmission capabilities could then be reactivated only through the actions of an authorized dealer of the device or by the company providing product support for the device.

In another embodiment of the present invention, inappropriate content can be filtered from data that is transmitted from wireless transmission devices. Referring back to FIG. 1, inappropriate content may be captured and stored on a wireless transmission device 100. However, when a user transmits the data, the data is sent through filter 110 before arriving at the intended destination. Filter 110 may be housed or propagated from any location. For example, the transmitted data could be given only a cursory scan to detect the possibility of inappropriate content. If there is a low likelihood that any inappropriate content is housed in the data, it can be passed through to the intended destination. However, if it appears that there may be some type of inappropriate content in the data, the transmitted data could be given a more thorough scan. The secondary, more thorough scan may be implemented in any of a variety of manners, such as those mentioned previously. If the secondary scan shows the transmitted data has no inappropriate content, the data is passed through to its intended destination. However, if the data is found to contain inappropriate content, its transmission is blocked.

When the secondary scan blocks the transmission of the data, any of a variety of actions, such as those discussed previously, may again be taken. In one embodiment of the invention, the content, in addition to not being delivered to the intended destination, may be sent to a different location for human review. Following this review, the content may be directed back to the intended destination if it is not deemed inappropriate. Alternatively, if the content is deemed inappropriate, it may be deleted.

The description of the invention provided herein is merely exemplary in nature, and thus, variations that do not depart from the gist of the invention are intended to be within the scope of the embodiments of the present invention. Such variations are not to be regarded as a departure from the spirit and scope of the present invention.

What is claimed is:

1. A method of filtering undesirable visual data from being transmitted on a wireless device, comprising:
capturing the data on the wireless device;
storing the data on the wireless device;
determine whether the data is of a certain content type comprising said undesirable visual data; and
filtering the data if it is determined to be of the certain type.

2. The method of claim 1, further comprising:
scanning the data to determine if the data is of said certain content type comprising said undesirable visual data;
wherein said scanning of the data comprises using an algorithm that compares the data to a predetermined template.

3. The method of claim 1, further comprising:
disabling the transmission capabilities of the wireless device; and
alerting a third party of an attempt to transmit pornographic materials from the wireless device.

4. The method of claim 1, wherein the wireless device is selected from a group consisting of a wireless telephone, a digital camera, a camcorder, and a personal digital assistant.

5. The method of claim 1, wherein the certain content type is of a pornographic nature.

6. The method of claim 2, wherein the known set of parameters is a template of known pornographic and anatomical images.

7. The method of claim 2, wherein the known set of parameters is a percentage of exposed skin in the data.

8. The method of claim 1, wherein the data is scanned in response to an attempt to transmit the data from the wireless device.

9. The method of claim 1, wherein the filtering further comprises altering only a portion of the data.

10. A wireless device for preventing transmission of pornographic material, comprising:
means for capturing data;
a memory configured to store the data;
means for wirelessly transmitting visual data; and
a filter disposed on the wireless device and configured to detect the pornographic material.

11. The wireless device of claim 10, wherein the filter is configured to compare the visual data to a template and prevent transmission of the pornographic material to an intended destination.

12. The wireless device of claim 11, wherein the pornographic material is prevented from being transmitted by disabling transmission capabilities of the wireless device.

13. The wireless device of claim 11, wherein the pornographic material is prevented from being transmitted by altering the visual data to obscure portions of the visual data containing the pornographic material.

14. The wireless device of claim 11, wherein the pornographic material is prevented from being sent by deleting the visual data housing the pornographic material.

15. The wireless device of claim 14, wherein the wireless device is configured to notify a third party of an attempt to transmit the pornographic material.

16. The wireless device of claim 15, wherein the visual data transmission capabilities of the wireless device are disabled.

17. The wireless device of claim 11, wherein the template is a predefined grouping of pornographic content.

18. The wireless device of claim 11, wherein the wireless device is selected from a group consisting of a wireless telephone, a digital camera, a camcorder, and a personal digital assistant.

19. A wireless device configured to operate in a wireless communication network, the wireless device comprising:
means for capturing visual data;
means for transmitting the visual data;
means for scanning the visual data after the visual data is chosen to be transmitted to an intended target; and
means for preventing the transmission of pornographic material to the intended target.

20. The wireless device of claim 19, further comprising:
means for filtering the visual data, said means for filtering being located remotely from the wireless device.
